(19) United States
(12) Patent Application Publication
(10) Pub. No.: US 2026/0311474 A1
(43) Pub. Date: Oct. 8, 2026

(54) MATHEMATICAL FORMULA RECOGNITION METHOD AND APPARATUS, ELECTRONIC DEVICE, AND READABLE STORAGE MEDIUM

(71) Applicants: Beijing BOE Technology Development Co., Ltd., Beijing (CN); BOE Technology Group Co., Ltd., Beijing (CN)

(72) Inventors: Ruijiao SHI, Beijing (CN); Xianbin LIU, Beijing (CN)

(21) Appl. No.: 19/470,047

(22) PCT Filed: Apr. 17, 2024
(86) PCT No.: PCT/CN2024/088254

§ 371 Date: Sep. 28, 2025

(30) Foreign Application Priority Data
May 31, 2023 (CN) 202310638406.1

(51) Int. Cl. G06V 10/82; G06N 3/0455; G06V 10/77; G06V 10/774; G06V 30/19

(52) U.S. Cl. CPC G06V 10/82; G06N 3/0455; G06V 10/7715; G06V 10/774; G06V 30/1918

(57) ABSTRACT

The present disclosure relates to a mathematical formula recognition method and apparatus, an electronic device, and a readable storage medium. The method comprises: acquiring an original image comprising a mathematical formula; inputting the original image into a formula recognition model to obtain a predicted character set outputted by the formula recognition model, wherein the predicted character set includes character data and structural data; and, according to a preset formula format and the structural data, restoring the position of the character data in the mathematical formula to obtain the mathematical formula in the original image. In the present embodiments, a relative positional relationship of the character data can be represented by means of the provision of the structural data, thereby eliminating the problem of missing characters in a complex formula recognition process, improving the recognition accuracy.

### CROSS-REFERENCE TO RELATED APPLICATIONS

The present application is a U.S. National Phase Entry of International Application No. PCT/CN2024/088254 having an international filing date of Apr. 17, 2024, which claims a priority to Chinese Patent Application No. 202310638406.1 filed on May 31, 2023. The entire contents of the above-identified applications are incorporated herein by reference.

### TECHNICAL FIELD

The present disclosure relates to the technical field of data processing, and more particularly to a mathematical formula recognition method and apparatus, an electronic device, and a readable storage medium.

### BACKGROUND

At present, handwritten formula recognition is usually realized by encoding and decoding architecture. For example, an image of a handwritten formula is inputted into an encoder, and the encoder extracts an image feature map; then, the image feature map is inputted into a decoder, and the decoder performs character-by-character recognition of the handwritten formula, and finally, the handwritten formula is recognized.

The encoding-decoding architecture in the existing scheme is based on latex label for character-by-character prediction. However, when there are complex nested structures with fractions, radicals, exponents, logarithms, etc. in a formula to be recognized, it is easy to cause “{” or “}” to be lost, and especially when the formula to be recognized is long, it is easy to cause some characters to be lost in a recognition process, resulting in recognition errors and reducing the recognition accuracy.

### SUMMARY

The present disclosure provides a mathematical formula recognition method and apparatus, an electronic device, and a readable storage medium to solve the shortcomings of the related art.

According to a first aspect of an embodiment of the present disclosure, a mathematical formula recognition method is provided, the method includes: acquiring an original image including a mathematical formula; inputting the original image into a formula recognition model, to obtain a predicted character set outputted by the formula recognition model; wherein the predicted character set includes character data and structural data; restoring position of the character data in the mathematical formula according to a preset formula format and the structural data, to obtain the mathematical formula in the original image.

Optionally, the formula recognition model includes an encoder and a decoder; the encoder is configured to acquire an image feature map corresponding to the original image; the decoder is configured to determine the predicted character set corresponding to the original image according to the image feature map.

Optionally, the encoder includes a DenseNet network or a Transformer network.

Optionally, the decoder includes a multi-scale counting module, a cyclic decoding module, a feature fusion module, and a character prediction module; the multi-scale counting module is configured to convert the image feature map into a counting vector of a plurality of preset scales; the cyclic decoding module is configured to acquire a character latent vector according to the image feature map; the feature fusion module is configured to perform fusion processing on the counting vector, the character latent vector and a previous predicted character vector, to obtain a target vector; the character prediction module is configured to predict the character data and the structural data according to the target vector, respectively.

Optionally, the cyclic decoding module is further configured to acquire a context vector according to the image feature map; the feature fusion module is further configured to perform the fusion processing on the counting vector, the context vector, the character latent vector and the previous predicted character vector, to obtain the target vector.

Optionally, the feature fusion module is configured to perform linear conversion processing on the count vector, the context vector, the character latent vector, and the previous predicted character vector, respectively, to obtain a first linear vector, a second linear vector, a third linear vector, and a fourth linear vector; and acquire a sum vector of the first linear vector, the second linear vector, the third linear vector, and the fourth linear vector, to obtain the target vector.

Optionally, the multi-scale counting module includes at least two sub-counting modules and an element average sub-module; the at least two sub-counting modules include convolution kernels of different sizes and are used for outputting sub-vectors of a same size, wherein each sub-vector is used for representing a number of times of prediction of character data under a different scale; the element average sub-module is configured to acquire an average vector of at least two sub-vectors, to obtain a counting vector.

Optionally, the multi-scale counting module includes a first sub-counting module and a second sub-counting module; the first sub-counting module is configured to recognize feature information of a first preset scale in the image feature map, to obtain a first sub-vector; wherein the first sub-vector is used to represent a number of times of character data recognized by convolution kernels under the first preset scale; the second sub-counting module is configured to recognize feature information of a second preset scale in the image feature map, to obtain a second sub-vector; wherein the second sub-vector is used to represent a number of times of character data recognized by convolution kernels under the second preset scale.

Optionally, the first sub-counting module includes a first convolution unit, a channel unit, a conversion unit, and a pooling unit; the first convolution unit is configured to convert the image feature map into a first feature map using convolution kernels of a first preset size; the channel unit is configured to assign corresponding weights to different channels of the first feature map, to obtain an attention feature map, and multiply the attention feature map with the first feature map, to obtain a channel feature map; the conversion unit is configured to perform scale transformation processing on the channel feature map, to obtain a counting feature map; the pooling unit is configured to perform pooling processing on the counting feature map, to obtain the first sub-vector.

Optionally, the second sub-counting module includes a second convolution unit, a channel unit, a conversion unit, and a pooling unit; the second convolution unit is configured to convert the image feature map into a second feature map using convolution kernels of a second preset size; the channel unit is configured to assign corresponding weights to different channels of the second feature map, to obtain an attention feature map, and multiply the attention feature map with the second feature map, to obtain a channel feature map; the conversion unit is configured to perform scale transformation processing on the channel feature map, to obtain a counting feature map; the pooling unit is configured to perform pooling processing on the counting feature map, to obtain the second sub-vector.

Optionally, the multi-scale counting module further includes a third sub-counting module, and the third sub-counting module is configured to recognize feature information of a third preset scale in the image feature map, to obtain a third sub-vector.

Optionally, the third sub-counting module includes a third convolution unit, a channel unit, a conversion unit, and a pooling unit; the third convolution unit is configured to convert the image feature map into a third feature map using convolution kernels of a third preset size; the channel unit is configured to assign corresponding weights to different channels of the third feature map, to obtain an attention feature map; and multiply the attention feature map with the third feature map, to obtain a channel feature map; the conversion unit is configured to perform scale transformation processing on the channel feature map, to obtain a counting feature map; the pooling unit is configured to perform pooling processing on the counting feature map, to obtain the third sub-vector.

Optionally, the cyclic decoding module includes a gate cyclic unit; the gate cyclic unit is configured to generate the character latent vector according to a latent vector and the previous predicted character vector.

Optionally, the cyclic decoding module includes a first gate cyclic unit and a second gate cyclic unit; the first gate cyclic unit is configured to generate a first gate vector according to the latent vector and the previous predicted character vector; the second gate cyclic unit is configured to generate the character latent vector according to the first gate vector.

Optionally, the cyclic decoding module further includes an attention sub-module; the attention sub-module is configured to generate a context vector according to the image feature map, an all-zero tensor, and the first gate vector; the second gate cyclic unit is configured to generate the character latent vector according to the first gate vector and the context vector.

Optionally, the attention sub-module includes a weight acquisition sub-module and a context acquisition sub-module; the weight acquisition sub-module is configured to perform convolution processing and linear processing on the all-zero tensor to obtain a first feature vector, perform convolution processing on the image feature map to obtain a second feature vector, and perform linear processing on the first gate vector to obtain a third feature vector; and perform addition processing on the first feature vector, the second convolution vector, and the third feature vector, to obtain a fourth feature vector; the context acquisition sub-module is configured to perform first activation processing, linear conversion processing and second activation processing on the fourth feature vector, respectively, to obtain an attention weight, and multiply the image feature map with the attention weight, and then perform summation processing on the image feature map, to obtain the context vector.

Optionally, the character prediction module includes a character prediction sub-module and a structure prediction sub-module; the character prediction sub-module is configured to process the target vector to obtain the predicted character data; the structure prediction sub-module is configured to process the target vector to obtain the predicted structural data.

Optionally, the character prediction sub-module includes a linear conversion unit and an activation unit; the linear conversion unit is configured to linearly convert the target vector; the activation unit is configured to perform activation processing on the linearly converted vector, to obtain the predicted character data.

Optionally, the structure prediction sub-module includes a linear conversion unit and an activation unit; the linear conversion unit is configured to linearly convert the target vector; the activation unit is configured to perform activation processing on the linearly converted vector, to obtain the predicted structural data.

Optionally, the formula recognition model is trained by following steps, including: acquiring training sample data; wherein the training sample data includes a plurality of data sets of the mathematical formulas; each data set includes character data and structural data obtained after expanding according to the preset formula format; the structural data is used to represent a relative positional relationship of part of characters in a mathematical formula; training the formula recognition model to be trained using the training sample data, to obtain the predicted character set outputted by the formula recognition model; wherein the predicted character set includes character data and structural data; stopping the training when the character data is determined to satisfy a preset condition, to obtain the formula recognition model that has completed training.

Optionally, the character data is determined to satisfy the preset condition includes: acquiring an occurrence frequency of each character data in the predicted character set, to obtain a predicted frequency corresponding to each character data; acquiring a difference between the predicted frequency corresponding to each character data and a labeled frequency in a label of the training sample data, to obtain a prediction error value corresponding to each character data; acquiring an average value of prediction error values corresponding to the character data in the predicted character set, to obtain an error average value; and determining that the character data satisfies the preset condition when the error average value is determined to be less than or equal to a preset average value threshold.

Optionally, the training sample data is acquired by the following steps, including: acquiring a plurality of original images including mathematical formulas; acquiring character data corresponding to each original image; creating structural data according to the preset formula format and the character data and arranging the character data, to obtain training sample data corresponding to each original image.

According to a second aspect of an embodiment of the present disclosure, a mathematical formula recognition apparatus is provided, the apparatus includes: an original image acquisition module configured to acquire an original image including a mathematical formula; a predicted set acquisition module configured to input the original image to a formula recognition model, to obtain a predicted character set outputted by the formula recognition model; wherein the predicted character set includes character data and structural data; a mathematical formula acquisition module configured to restore position of the character data in the mathematical formula according to a preset formula format and the structural data, to obtain the mathematical formula in the original image.

According to a third aspect of an embodiment of the present disclosure, an electronic device is provided, the electronic device includes: a processor; a memory for storing a computer program executable by the processor; wherein the processor is configured to execute a computer program in the memory to implement the method according to the first aspect.

According to a fourth aspect of an embodiment of the present disclosure, a computer-readable storage medium is provided, wherein when an executable computer program in the storage medium is executed by a processor, the method according to the first aspect can be implemented.

The technical solutions provided in the embodiments of the present disclosure may include the following beneficial effects:
as can be seen from the above embodiments, in the solutions provided in the embodiments of the present disclosure, an original image including a mathematical formula can be acquired; then, the original image is inputted into a formula recognition model to obtain a predicted character set outputted by the formula recognition model; wherein the predicted character set includes character data and structural data; subsequently, according to a preset formula format and the structural data, the position of the character data in the mathematical formula is restored, to obtain the mathematical formula in the original image. In such a way, in the present embodiments, a relative positional relationship of the character data can be represented by providing the structural data, so that the problem of missing characters in a complex formula recognition process can be eliminated, which is helpful to improve the recognition accuracy.

It should be understood that the above general description and the following detailed description are exemplary and explanatory only and are not intended to limit the present disclosure.

### BRIEF DESCRIPTION OF DRAWINGS

The drawings herein are incorporated in the specification and constitute a part of the specification, illustrate the embodiments conforming to the present disclosure, and together with the specification, are used for explaining the principle of the present disclosure.

FIG. 1 is a flowchart of a mathematical formula recognition method according to an exemplary embodiment.

FIG. 2 is a block diagram of a formula recognition model according to an exemplary embodiment.

FIG. 3 is a block diagram of a decoder according to an exemplary embodiment.

FIG. 4 is a block diagram of a multi-scale counting module according to an exemplary embodiment.

FIG. 5 is a block diagram of a first sub-counting module according to an exemplary embodiment.

FIG. 6 is a block diagram of a cyclic decoding module according to an exemplary embodiment.

FIG. 7 is a block diagram of an attention sub-module according to an exemplary embodiment.

FIG. 8 is a block diagram of a character prediction module according to an exemplary embodiment.

FIG. 9 is a block diagram of a formula recognition model according to an exemplary embodiment.

FIG. 10 is a flowchart of a training formula recognition model according to an exemplary embodiment.

FIG. 11 is a schematic diagram of a relationship of a mathematical formula, a preset formula format, and latex label according to an exemplary embodiment.

FIG. 12 is a flowchart of training a formula recognition model according to an exemplary embodiment.

FIG. 13 is a block diagram of a mathematical formula recognition apparatus according to an exemplary embodiment.

### DETAILED DESCRIPTION

Herein, exemplary embodiments will be illustrated, and their examples are shown in the drawings. When following description refers to the drawings, unless otherwise indicated, a same number in different drawings indicates a same or similar element. The exemplary embodiments described below do not represent all embodiments consistent with the present disclosure. Rather, they are merely examples of an apparatus according to some aspects of the present disclosure as detailed in the appended claims. It should be noted that the following embodiments and features in the embodiments may be combined with each other if there is no conflict.

Considering that mathematical formulas with complex structures in the related art may lose “{” or “}” in the recognition process, especially when the formula to be recognized is long, some characters are easily lost in the recognition process, and the problem of mathematical formula recognition errors may occur.

In order to solve the above technical problems, an embodiment of the present disclosure provides a mathematical formula recognition method, and the inventive concept includes:

First, a structural information is added into a training sample data, wherein the structural information may represent a relative positional relationship of some characters in a mathematical formula, making the mathematical formula recognition clearer and more accurate; when the formula recognition model is trained, the formula recognition model can be made to predict a position of each character data in the mathematical formula more accurately, improving the accuracy of the formula recognition model.

Second, a decoder of the formula recognition model is provided with a multi-scale counting module, wherein the multi-scale counting module may acquire a frequency of occurrence of character data in a predicted character set, and may construct a loss function by using the frequency to realize supervising of a training process of the formula recognition model, which is beneficial for improving the accuracy of character recognition by the formula recognition model, and further beneficial for improving the accuracy of overall recognition of the mathematical formulas.

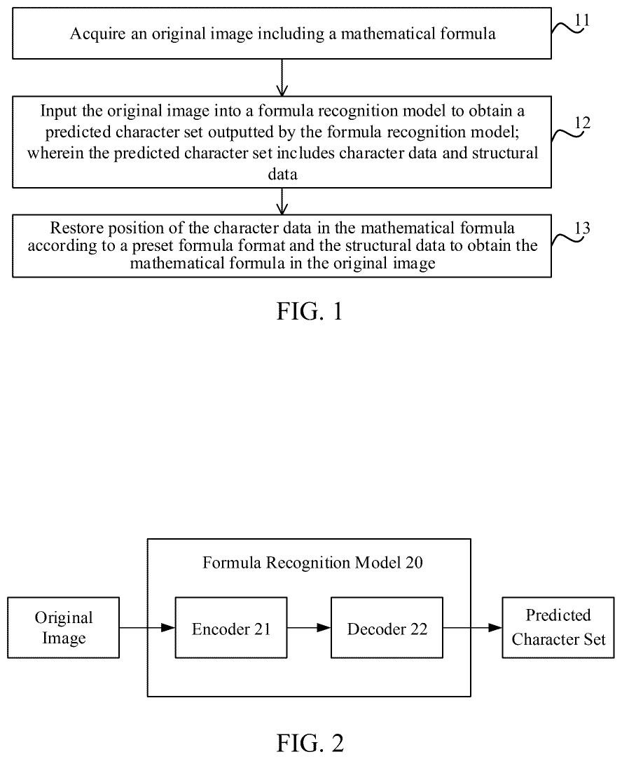

An embodiment of the present disclosure provides a mathematical formula recognition method, which may be applied to an electronic device, and the electronic device may include, but is not limited to, a device such as a smartphone, a tablet computer, a smart display screen, or an electronic whiteboard. FIG. 1 is a flowchart of a mathematical formula recognition method according to an exemplary embodiment.

Referring to FIG. 1, a mathematical formula recognition method includes steps 11 to 13:

In step 11, an original image including a mathematical formula is acquired.

In the present embodiment, the electronic device may acquire the original image including a mathematical formula. In one example, the electronic device may be provided with an image acquisition module such as a camera or an image sensor, etc. When there is a need to acquire an original image, for example, when there is an object in a preview region of the image acquisition module, for example, the object may be a sheet of paper on which a mathematical formula is written, the electronic device may control the image acquisition module to photograph the object, thereby obtaining the original image. In another example, the electronic device may be provided with a communication module, such as a WiFi module, an infrared module, a USB module, or the like, and the electronic device may communicate with a peer communication module of another device through the communication module, thereby reading an original image including a mathematical formula from the another device.

It should be noted that the electronic device does not determine whether the mathematical formula is included in the image when acquiring the image. In subsequent embodiments, for convenience of description, mathematical formulas are included in images by default.

In addition, an original image in each of the following embodiments may be a color image (i.e., an RGB image) or a grayscale image. In one example, an original image is implemented using a grayscale image, thereby reducing the amount of data processing of the formula recognition model and improving recognition efficiency.

In step 12, the original image is inputted into a formula recognition model to obtain a predicted character set outputted by the formula recognition model; wherein the predicted character set includes character data and structural data.

In the present embodiment, the formula recognition model may be stored in the electronic device. The formula recognition model may include an encoder and a decoder. Referring to FIG. 2, the encoder 21 is configured to acquire an image feature map corresponding to the original image; the decoder 22 is configured to determine a predicted character set corresponding to the original image according to the image feature map.

In one example, the encoder 21 may include an implementation of a DenseNet network or a Transformer network. Taking an implementation of the encoder 21 using the DenseNet network as an example, wherein an input data of the DenseNet network is an original image with a size of H*W*1, and an output data of the DenseNet network is an image feature map with a size of H/16*W/16*684, wherein H represents a height of the original image, and W represents a width of the original image.

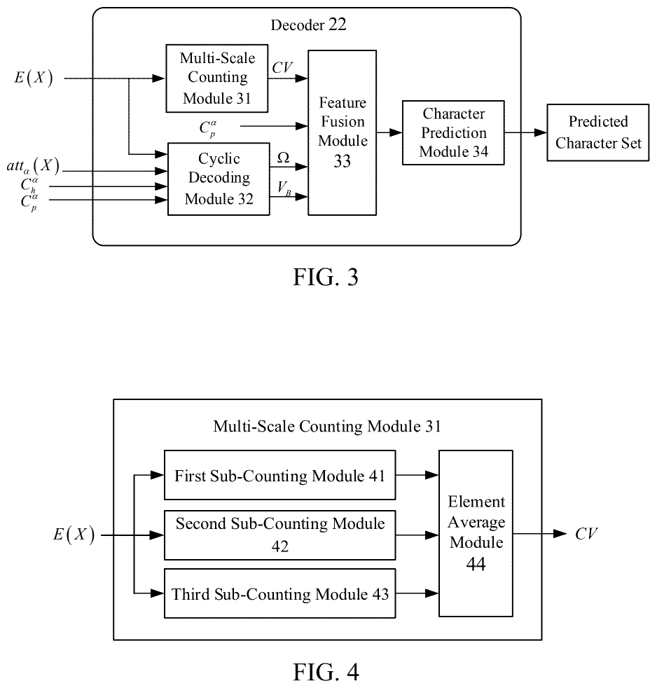

In one example, the decoder 22 includes a multi-scale counting module, a cyclic decoding module, a feature fusion module, and a character prediction module. Referring to FIG. 3, a multi-scale counting module (MSCM) 31 is used to convert the image feature map E(X) into a counting vector (CV) of a plurality of preset scales.

The cyclic decoding module 32 acquires a character latent vector M and a context vector corresponding to the image feature map Q;
the feature fusion module 33 is configured to perform a linear conversion processing on the counting vector CV, the character latent vector M, and a previous predicted character vector

$${C}_{p}^{α}$$

to obtain a target vector LB;
the character prediction module 34 is configured to respectively predict the character data and the structural data according to the target vector LB, and the character data and the structural data constitute the predicted character set.

It should be noted that, in an example, the target vector LB is a sum vector of a first linear vector, a second linear vector, a third linear vector, and a fourth linear vector, that is, a sum value of elements in all linear vectors at a same position is obtained as a value of the sum vector at the same position, so that dimensions of the target vector and each linear vector are the same after the summation process. For example, if all of the first linear vector, the second linear vector, the third linear vector, and the fourth linear vector are all linear vectors of a dimension 1*512, then the target vector is also a linear vector of a dimension 1*512.

In an example, the multi-scale counting module 31 includes at least two sub-counting modules and an element average sub-module; the at least two sub-counting modules include convolution kernels of different sizes and are used for outputting sub-vectors of a same size, and each sub-vector is used for representing the number of predictions about character data under different scales; the element average sub-module is used for acquiring an average vector of at least two sub-vectors to obtain a counting vector.

In an example, the multi-scale counting module 31 includes a first sub-counting module and a second sub-counting module; the first sub-counting module is configured to recognize feature information of a first preset scale in the image feature map to obtain a first sub-vector; the second sub-counting module is configured to recognize feature information of a second preset scale in the image feature map to obtain a second sub-vector.

In another example, the multi-scale counting module further includes a third sub-counting module, and the third sub-counting module is configured to recognize feature information of a third preset scale in the image feature map to obtain a third sub-vector. In the present example, the multi-scale counting module 31 includes a first sub-counting module, a second sub-counting module, a third sub-counting module, and an element average sub-module. Referring to FIG. 4, there are a first sub-counting module 41, a second sub-counting module 42, a third sub-counting module 43, and an element average module 44.

The first sub-counting module 41 is configured to recognize feature information of a first preset scale in the image feature map E(X) to obtain a first sub-vector.

The second sub-counting module 42 is configured to recognize feature information of a second preset scale in the image feature map E(X) to obtain a second sub-vector.

The third sub-counting module 43 is configured to recognize feature information of a third preset scale in the image feature map E(X) to obtain a third sub-vector.

The element average module 44 is configured to acquire an average vector of the first sub-vector, the second sub-vector, and the third sub-vector to obtain a counting vector CV. Herein, the counting vector CV is used to represent the quantity of each character.

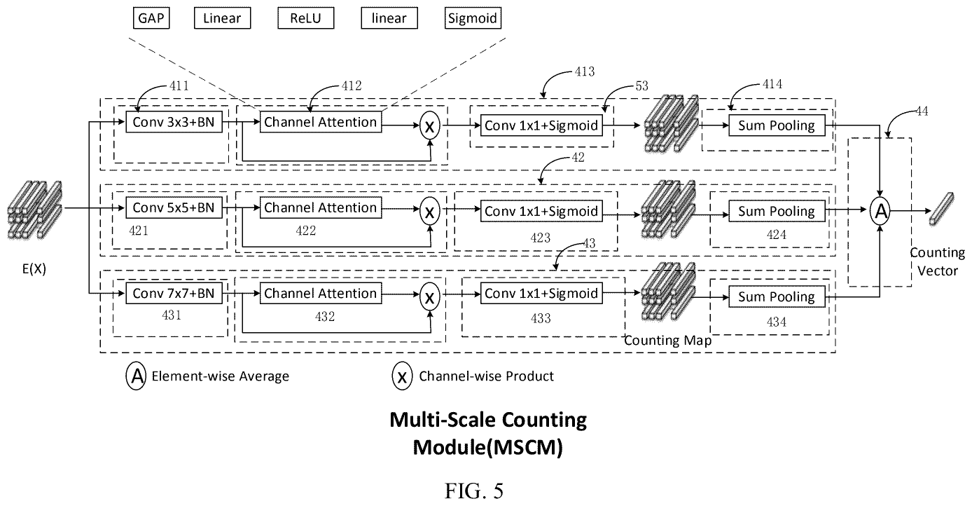

In one embodiment, referring to FIG. 5, the first sub-counting module 41 includes a first convolution unit 411 (e.g. Conv3*3+BN), a channel unit 412, a conversion unit 413 (e.g. Conv1*1+Sigmoid), and a pooling unit 414 (e.g. Sum Pooling).

The first convolution unit 411 is configured to convert the image feature map E(X) into a first feature map using convolution kernels of a first preset size. The first convolution unit further includes a BN (Batch Normalization, i.e. normalization of batch samples) layer for converting the image feature map E(X) into a feature map of a preset dimension. Further, the first convolution unit includes convolution kernels Conv, and in one example, a size of a convolution kernel, that is, the first preset size, is 3*3*684; and the quantity of the convolution kernels is 512, so that a dimension of the first feature map output by the first convolution unit is H/16*W/16*512.

The channel unit 412 is configured to assign corresponding weights to different channels of the first feature map to obtain an attention feature map, and multiply the attention feature map and the first feature map to obtain a channel feature map. In an example, the channels of interest may include, but not limited to, following activation functions: ReLU and Sigmoid. Of course, the channels of interest may also include functions such as GAP and Linear, etc. Since different functions have different output value ranges, corresponding weights may be assigned to different channels of the first feature map to select ranges of interest values under different channels. Then, the channel unit 52 may multiply a weight value of each channel with the feature map of the preset dimension to obtain a channel feature map.

Taking a channel of interest including a GAP function as an example, the GAP function may perform average pooling on the first feature map, that is, calculate an average value of a plane of H/16*W/16 to obtain a numerical value corresponding to the plane; after 512 times, a channel characteristic map of a dimension H/16*W/16*512 may be obtained.

The conversion unit 413 is configured to perform scale transformation processing on the channel feature map to obtain a counting feature map. The conversion unit 413 is configured to convert a channel feature map of different input dimensions to a feature map of another preset dimension, which is hereinafter referred to as a counting map. In an example, the conversion unit includes convolution kernels and a Sigmoid activation function. A size of a convolution kernel is 1*1*512, and the quantity of the convolution kernels is K, so that K characters may be recognized, that is, the counting feature map is a vector of a dimension 1*K.

The pooling unit 414 is configured to perform pooling processing on the counting feature map to obtain a first sub-vector.

Continuing to refer to FIG. 5, the first convolution unit 411 performs a 3*3*684 convolution through the convolution kernels, and after convolution through 512 convolution kernels, the quantity of channels of the image feature map may be adjusted from a dimension 684 to a dimension 512. Then, the channel unit 412 may acquire a weight value of each of 512 channels, and multiply the weight value of each channel with the first feature map output by the first convolution unit 411 to perform weighting to obtain a channel feature map of a dimension H/16*W/16*512. Thereafter, the conversion unit 413 adjusts the quantity of channels of the first feature map from a dimension 512 to a dimension 208 through 1*1*208 convolution. It should be noted that the dimension 208 described above are character data of a recognition network, and can be adjusted according to the pattern. In this case, a dimension of the counting feature map is H*W*208. Thereafter, the pooling unit 414 may sum up each H*W plane to obtain a first sub-vector of a dimension 1*208, wherein a pixel value of each channel of 208 channels of the first sub-vector respectively corresponds to the number of occurrences of a representation character in the current formula.

Continuing to refer to FIG. 5, the second sub-counting module 42 includes a second convolution unit 421, a channel unit 422, a conversion unit 423, and a pooling unit 424. Herein, the second convolution unit 421 is configured to convert the image feature map E(X) into a second feature map using convolution kernels of a second preset size; the channel unit 422 is configured to assign corresponding weights to different channels of the second feature map to obtain an attention feature map, and multiply the attention feature map with the second feature map to obtain a channel feature map; the conversion unit 423 is configured to perform scale conversion processing on the channel feature map to obtain a counting feature map; the pooling unit 424 is configured to perform pooling processing on the counting feature map to obtain a second sub-vector.

Noted that a structure of the second sub-counting module 42 is the same as that of the first sub-counting module 41, except that the convolution unit of the second sub-counting module 42 is different from that of the first sub-counting module 41, that is, the second sub-counting module 42 converts the image feature map to the second preset size instead of the first preset size. In an example, the second convolution unit 421 includes convolution kernels having a size of 5*5*684, that is, the second preset size is 5*5*684, and the quantity of the convolution kernels is 512, so that a dimension of the second feature map outputted by the second convolution unit 421 is H/16*W/16*512. And, a dimension of the second sub-vector is H*W*208.

Continuing to refer to FIG. 5, the third sub-counting module 43 includes a third convolution unit 431, a channel unit 432, a conversion unit 433, and a pooling unit 434. Herein, the third convolution unit 431 is configured to convert the image feature map E(X) into a third feature map using convolution kernels of a third preset size; the channel unit 432 is configured to assign corresponding weights to different channels of the third feature map to obtain an attention feature map; and multiply the attention feature map with the third feature map to obtain the channel feature map; the conversion unit 433 is configured to perform scale conversion processing on the channel feature map to obtain a counting feature map; the pooling unit 434 is configured to perform pooling processing on the counting feature map to obtain a third sub-vector.

It should be noted that a structure of the third sub-counting module 43 is the same as that of the first sub-counting module 41, except that the convolution unit of the third sub-counting module 43 is different from that of the first sub-counting module 41. In an example, the third convolution unit 431 includes convolution kernels having a size of 7*7*684, that is, a third preset size is 7*7*684. That is, a dimension of the third sub-vector is H*W*208.

In an embodiment, the cyclic decoding module includes gate cyclic units configured to generate a character latent vector according to a latent vector and a previous predicted character vector. In an example, the cyclic decoding module includes a first gate cyclic unit and a second gate cyclic unit; the first gate cyclic unit is configured to generate a first gate vector according to the latent vector and the previous predicted character vector; the second gate cyclic unit is configured to generate the character latent vector according to the first gate vector. Noted that the quantity of gate cyclic units can be selected according to a specific scenario, and when the recognition accuracy is satisfied, the corresponding scheme falls within the scope of protection of the present disclosure.

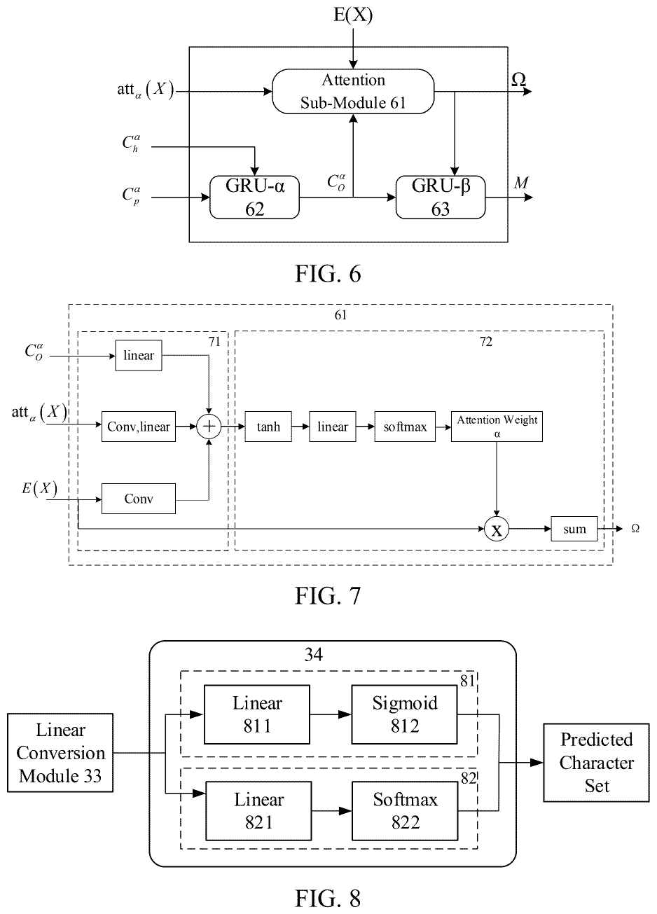

In another example, the cyclic decoding module further includes an attention sub-module (e.g. attention model), and referring to FIG. 6, the cyclic decoding module 32 includes an attention sub-module 61, a first gate cyclic unit 62, and a second gate cyclic unit 63; the first gate cyclic unit 62 is configured to generate a first gate vector

$${C}_{o}^{α}$$

according to a latent vector

$${C}_{h}^{α}$$

and a previous predicted character vector

$${C}_{p}^{α} ;$$

both the two input, i.e. the latent vector

$${C}_{h}^{α}$$

and a previous predicted character vector

$${C}_{p}^{α} ,$$

of the first gate loop unit 62 are of a dimension 256. An initial value generated for the previous predicted character vector

$${C}_{p}^{α}$$

is a 256-dimensional vector representation of a starting symbol “<sos>”, and a value after a first time is a result of a previous training process. An initial value of a latent vector

$${C}_{h}^{α}$$

is a linear transformation (of a dimension 1*256) of an average value (of a dimension 1*684) of pixels of each channel of the image feature map E(X) outputted by the encoder, that is, a vector of a dimension 1*256 corresponding to the image feature map E(X); and when it is not a first iteration,

$${C}_{h}^{α} = M ,$$

wherein M is a character latent vector M outputted by the second gate cyclic unit 63.

It should be noted that the previous predicted character vector

$${C}_{p}^{α}$$

is character data that can be obtained after character prediction is performed based on the character latent vector M; then, a table lookup operation is performed according to the character data to query a vector corresponding to the character data, and the queried vector is used as a value of the previous predicted character vector

$${C}_{p}^{α}$$

to reach an effect of updating the previous predicted character vector

$${C}_{p}^{α} .$$

The attention sub-module 61 is configured to generate a context vector Ω according to the image feature map E(X), an all-zero tensor attₐ(X) and a first gate vector

$${C}_{O}^{α} ;$$

an input of the attention sub-module 61 is E(X), and the dimension of the E(X) is H/16*W/16*684. An output result of the first gate cyclic unit 62 is

$${C}_{O}^{α} ,$$

and the dimension of the

$${C}_{O}^{α}$$

is 1*256. An initialization dimension of the all-zero tensor att_{α}(X) is 1*1*H/16*W/16, and the all-zero tensor att_{α}(X) is used to record historical regions of interest.

It should be noted that, in this example, the all-zero tensor att_{α}(X) means that an initialization value of a vector is set to all-zero, thus facilitating the operation. Of course, the initialization value may also be set to other random numbers, and the corresponding results may also be obtained. The value of the all-zero tensor att_{α}(X) in the non-first iteration is att_{α}(X)=att_{α}(X)+α. Herein α is an update vector after each iteration by the attention sub-module 61 illustrated in FIG. 7.

The second gate cyclic unit 63 is configured to generate the character latent vector M according to the first gate vector

$${C}_{O}^{α}$$

and the context vector Ω. An output result of the second gate cyclic unit 63 is M, and the dimension of M is 1*256.

Referring to FIG. 7, the attention sub-module 61 includes a weight acquisition sub-module 71 and a context acquisition sub-module 72.

The weight acquisition sub-module 71 is configured to perform convolution and linear processing (i.e. Conv+linear in FIG. 7) on the all-zero tensor att_{α}(X) to obtain a first feature vector, and perform convolution processing (i.e. Conv in FIG. 7) on the image feature map E(X) to obtain a second feature vector, and perform linear processing (i.e. linear in FIG. 7) on the first gate vector

$${C}_{O}^{α}$$

to obtain a third feature vector; and perform addition processing (i.e. “+” in FIG. 7) on the first feature vector, the second convolution vector, and the third feature vector to obtain a fourth feature vector. The addition processing refers to adding a processed vector of a dimension H/16*W/16*512 of the all-zero tensor att_{α}(X) and a processed vector of a dimension H/16*W/16*512 of the image feature map E(X) to obtain a sum vector of a dimension H/16*W/16*512; then, the first gate vector

$${C}_{O}^{α}$$

is configured to perform linear processing (i.e. linear in FIG. 7) to obtain a vector of a dimension 1*512; subsequently, continuously sum up the sum vector of the dimension H/16*W/16*512 and the vector of the dimension 1*512 to obtain the fourth feature vector of the dimension H/16*W/16*512.

The context acquisition sub-module 72 is configured to respectively perform first activation processing (with a activation function tanh), linear conversion processing (linear) and second activation processing (with an activation function softmax) on the fourth feature vector to obtain an attention weight α; and multiply (i.e. “×” in FIG. 7) the image feature map E(X) with the attention weight, and then perform summation processing (i.e. sum in FIG. 7) to obtain the context vector Ω.

In this embodiment, the attention sub-module 61 adopts a Coverage mechanism to avoid repeated recognition, the context vector Ω satisfies Ω=ΣₕΣ_{w}E(X)×α, and att_{α}(X)=att_{α}(X)+α is inputted in the next iteration. After the linear processing is performed on the first gate vector

$${C}_{O}^{α} ,$$

the quantity of channels of the first gate vector

$${C}_{O}^{α}$$

is adjusted to a dimension 512. After the att_{α}(X) is subjected to the convolution layer (e.g. a size of a convolution kernel is 11*11, padding=5, and a step size is 1) and the linear transformation processing, the channels of the att_{α}(X) are adjusted to the dimension 512, and after 1*1 convolution processing is performed on the image feature map E(X), the quantity of channels of the image feature map E(X) is adjusted to 512. Then, the first sub-vector, the second sub-vector and the third sub-vector after the above three channel operations are added together, and then activated by the activation function tanh, then the quantity of channels is compressed to 1 through linear transformation, and finally the attention weight α is obtained after activation by the activation function softmax.

Referring to FIG. 8, the character prediction module includes a character prediction sub-module 81 and a structure prediction sub-module 82. The character prediction sub-module 81 is configured to process a target vector to obtain predicted character data; the structure prediction sub-module 82 is configured to process the target vector to obtain predicted structural data. The character data and the structural data constitute a predicted character set.

In one example, the character prediction sub-module 81 includes a linear conversion unit (i.e. Linear in FIG. 8) and an activation unit (i.e. Sigmoid in FIG. 8). The linear conversion unit 811 is configured to linearly convert the target vector; the activation unit 812 is configured to perform activation processing on the linear converted vector to obtain predicted character data.

In one example, the structure prediction sub-module 82 includes a linear conversion unit (i.e. Linear in FIG. 8) and an activation unit (i.e. softmax in FIG. 8). The linear conversion unit is configured to linearly convert the target vector; the activation unit is configured to activate the linearly converted vector to obtain predicted character data.

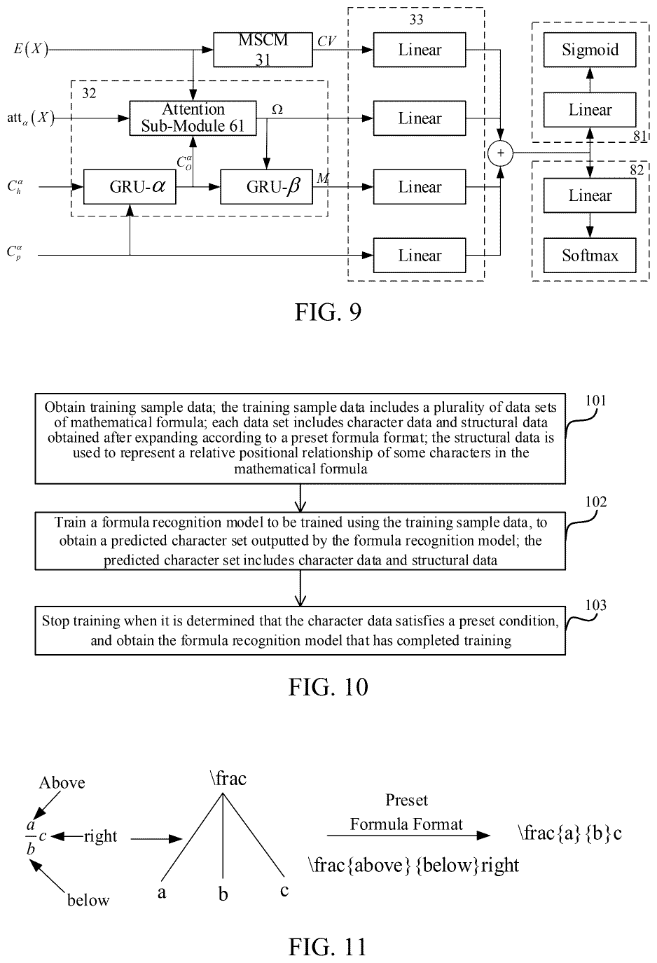

Combining FIGS. 2 to 8, in a possible embodiment, a structure of the formula recognition model may be as shown in FIG. 9.

Referring to FIG. 9, by setting the multi-scale counting module 31 and the cyclic decoding module 32 in the formula recognition model, features in regions of different scales in the image feature map can be recognized, which is beneficial for improving the detection accuracy of characters.

Referring to FIG. 10, a training process of the formula recognition model includes steps 101 to 103.

In step 101, training sample data is obtained; the training sample data includes a plurality of data sets of mathematical formulas; each data set includes character data and structural data obtained after expanding according to a preset formula format; the structural data is used to represent a relative positional relationship of part of characters in the mathematical formula.

In this step, the electronic device may obtain the training sample data. It can be understood that the training sample data includes a plurality of data sets of mathematical formulas, and each data set includes character data and structural data obtained by expanding according to a preset formula format; the structural data is used to represent a relative positional relationship of part of characters in the mathematical formula.

In this step, a mathematical formula includes at least one of the following structures: fractions, subscripts, superscripts, radicals, overlines, overline arrows, triangles, limits, summation symbols, and the like. The symbols for each of the above structures are \frac, _, \hat{ }, \sqrt, \overline, \overrightarrow, \widehat, \limits and \sum, respectively. It can be understood that the following structures such as log, In, lg, or index in a mathematical formula are also applicable to the scheme of the present disclosure.

TABLE 1
Mathematical formulas of different structures and their latex representations

| Mathematical formulas | Latex representations |
|---|---|
| $\frac{π}{4} + \text{?}$ | \frac { \pi } { 4 } + 2 k \pi |
| x₁ + x₂ = 9 | x _ { 1 } + x _ { 2 } = 9 |
| (n − 2) 2ⁿ⁻¹ | ( n − 2 ) 2 ∧ { n − 1 } |
| \sqrt{3}. | \sqrt { 3 } |
| 7̅ [symbol] | \overline{7} |
| ${\vec{ab}}^{\text{?}}$ | \overrightarrow { a b } |
| ŷ = 0.85x + 0.6 [symbol] | \widehat { y } = 0.85 x + 0.6 |
| ${lim}_{Δ x \to 0} \text{?}$ | \lim \limits_{ \triangle x \rightarrow 0 } \frac { 2 x } { 3 } |
| ${\sum }_{i = 1}^{6} {x}_{i} {y}_{i} = {x}_{3} {y}_{4} + \text{?}$ | \sum _ { i = 1 } ^{∧} { 6 } x _ { i } y _ { i } = x _ { 3 } y _ { 4 } + 2 |

See Table 1. There are seven positional relationships in the mathematical formula, i.e., inside, right, above, below, and left superscript (short for left_sup, such as square

$$\sqrt[5]{3} ) ,$$

subscript (short for sub), superscript (short for sup).

Taking a mathematical formula including fractions as an example, see FIG. 11, which illustrates the relationship between the character position in the mathematical formula and the latex label. Referring to FIG. 11, an upper part (above) in a formula

$$\frac{a}{b} c$$

is a character a, a lower part (below) in the formula

$$\frac{a}{b} c$$

is a character b, and a right side (right) in the formula

$$\frac{a}{b} c$$

is a character c; when the preset formula format is \frac {above} {below} right, the above formula

$$\frac{a}{b} c$$

can be written as \frac{a} {b}c.

In this embodiment, training sample data may be formed by combining the positional relationship of characters in the mathematical formula and the preset structure shown in FIG. 11.
1. If the mathematical formula is

$$P ( xi = 0 ) = \frac{{C}_{11}^{4}}{{C}_{14}^{4}} = \frac{330}{1101} ,$$

the training sample data is shown in Table 2.

TABLE 2
Training sample data

| | | | | | | | |
|---|---|---|---|---|---|---|---|
| P | None | None | None | None | None | None | None |
| ( | None | None | None | None | None | None | None |
| \xi | None | None | None | None | None | None | None |
| =0 | None | None | None | None | None | None | None |
| ) | None | None | None | None | None | None | None |
| \frac | None | None | None | None | None | None | None |
| struct | above | below | None | None | None | None | right |
| C | None | None | None | None | None | None | None |
| struct | None | None | sub | sup | None | None | None |
| 1 | None | None | None | None | None | None | None |
| 1 | None | None | None | None | None | None | None |
| <eos> | None | None | None | None | None | None | None |
| 4 | None | None | None | None | None | None | None |
| <eos> | None | None | None | None | None | None | None |
| C | None | None | None | None | None | None | None |
| struct | None | None | sub | sup | None | None | None |
| 1 | None | None | None | None | None | None | None |
| 4 | None | None | None | None | None | None | None |
| <eos> | None | None | None | None | None | None | None |
| 4 | None | None | None | None | None | None | None |
| <eos> | None | None | None | None | None | None | None |
| = | None | None | None | None | None | None | None |
| \frac | None | None | None | None | None | None | None |
| struct | above | below | None | None | None | None | None |
| 3 | None | None | None | None | None | None | None |
| 3 | None | None | None | None | None | None | None |
| 0 | None | None | None | None | None | None | None |
| <eos> | None | None | None | None | None | None | None |
| 1 | None | None | None | None | None | None | None |
| 0 | None | None | None | None | None | None | None |
| 0 | None | None | None | None | None | None | None |
| 1 | None | None | None | None | None | None | None |
| <eos> | None | None | None | None | None | None | None |

2. If the mathematical formula is

$$\sqrt[3]{b} = - 2 ,$$

the training sample data is shown in Table 3.

TABLE 3
Training sample data

| | | | | | | | |
|---|---|---|---|---|---|---|---|
| \sqrt | None | None | None | None | None | None | None |
| struct | None | None | None | None | Left sup | inside | right |
| 3 | None | None | None | None | None | None | None |
| <eos> | None | None | None | None | None | None | None |
| b | None | None | None | None | None | None | None |
| <eos> | None | None | None | None | None | None | None |
| = | None | None | None | None | None | None | None |
| - | None | None | None | None | None | None | None |
| 2 | None | None | None | None | None | None | None |
| <eos> | None | None | None | None | None | None | None |

It should be noted that in Tables 2 and 3, “<eos>” is a terminator, a last <eos> indicates an end of an entire formula recognition, and a middle <eos> indicates an end of each structure.

It should also be noted that in Tables 2 and 3, “struct” indicates the relative positional relationship (seven types) of characters are included here. If there is a positional relationship, such positional relationship is filled in the table, and if there is no positional relationship, “None” is filled in the table.

Combining Table 2 and Table 3, a first column (from top to bottom) is a formula using latex label, added structure “struct”, and relative positional relationship (i.e. 7 types); and a second to seventh columns are relative positional relationships after adding structure. The entire table constitutes training sample data. It can be seen that in the present embodiment, by adding structural data to the training sample data, a mathematical formula can be more accurately represented, so as to facilitate subsequent accurate restoration of the mathematical formula.

Based on the above principle, several data sets of mathematical formula can be obtained, and thus training sample data can be obtained.

In one embodiment, a plurality of original images including mathematical formulas handwritten by several users may be obtained by photographing the mathematical formulas. The electronic device stores a preset image recognition model, such as a convolutional neural network, and uses the image recognition model to recognize each original image to obtain character data corresponding to each original image. Or, character data corresponding to each original image is labeled by manual labeling, and the electronic device may obtain the inputted character data. Finally, the electronic device may create structural data according to a preset formula format and character data and arrange the character data, to obtain training sample data corresponding to each original image. The present embodiment can not only improve a diversity of mathematical formulas, but also improve acquisition efficiency of training sample data.

In step 102, a formula recognition model to be trained is trained using the training sample data to obtain a predicted character set outputted by the formula recognition model; the predicted character set includes character data and structural data.

In this step, the electronic device may sequentially input each training sample data to a formula recognition model to be trained for training, and the formula recognition model may process the training sample data to obtain a predicted character set. It can be understood that the predicted character set includes character data and structural data.

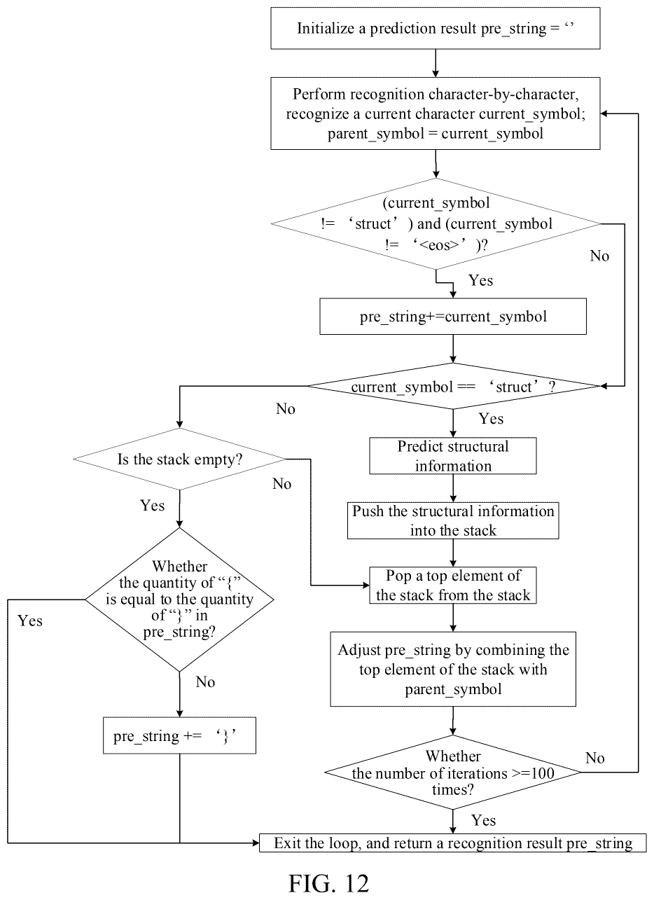

In this step, a reasoning process of the formula recognition model is shown in FIG. 12, referring to FIG. 12, the reasoning process includes: firstly, pushing structural information [position information, parent_symbol] into a stack, and initializing a prediction result pre_string=‘ ’ to store the recognized character data, and the character data is a representation of the latex label of the mathematical formula in FIG. 11. Recognition is performed character-by-character, a current character current_symbol is recognized, and parent_symbol=current_symbol, that is, a value of current_symbol is assigned to parent_symbol. Then, it is determined whether the current character current_symbol is not equal to ‘struct’ and current_symbol is not an ending character ‘eos>’. When current_symbol is not ‘struct’ and ‘<eos>’, pre_string+=current_symbol, that is, the current character is added to pre_string. Then, it is determined whether the current character current_symbol is ‘struct’. When current_symbol is ‘struct’ or ‘<eos>’, it is determined whether the current character current_symbol is ‘struct’.

For determining whether the current character current_symbol is ‘struct’, when current_symbol is ‘struct’, the structural information is predicted and the structural data is pushed into the stack, a top element of the stack is popped from the stack, and pre_string is adjusted by combining the top element of the stack with parent_symbol. When current_symbol is not ‘struct’, it is determined whether the stack is empty. When the stack is not empty, the top element of the stack is popped from the stack, and pre_string is adjusted in combination with the top element of the stack and parent_symbol. When the stack is empty, it is determined whether the quantity of “{” is equal to the quantity of “}” in pre_string. If the quantity of “{” is equal to the quantity of “}” in pre_string, the loop is exited and a recognition result is returned. If the quantity of “{” is not equal to the quantity of “}” in pre_string, a “}” is added to pre_string, that is, pre_string+=“}”. At this time, if the quantity of “{” is equal to the quantity of “}” in pre_string, the loop is exited and a recognition result is returned.

After adjusting pre_string, it can be determined whether the number of iterations exceeds 100 times. If the number of iterations exceeds 100 times, the loop is exited and a recognition result is returned. Otherwise, a character is recognized and the current character current_symbol is updated, and the loop is restarted until a recognition result is directly returned.

In step 103, when it is determined that the character data satisfies a preset condition, the training is stopped to obtain a formula recognition model that has completed training.

In this step, in order to improve the accuracy of formula recognition model recognition, a loss function is set in this embodiment. The loss function is constructed based on an occurrence frequency of each character in the label data of the training sample data and an occurrence frequency of each character in the predicted data set. In an example, the loss function includes three sub-loss functions which are respectively: a first sub-loss function which is used for comparing the quantity of each character in the counting feature map with the quantity of each character in the training sample data, and is a SmoothL1Loss function; a second sub-loss function which is used for judging a prediction result of structural information, and the second sub-loss function adopts a cross-entropy function; a third sub-loss function which is used for determining a prediction result of character information, and the third sub-loss function adopts a cross-entropy function.

In this step, the electronic device may determine that the character data satisfies a preset condition. For example, the electronic device may acquire an occurrence frequency of each character data in the predicted character set to obtain a predicted frequency corresponding to each character data; then, the electronic device may acquire a difference between the predicted frequency corresponding to each character data and a labeled frequency in the label of the training sample data, to obtain a prediction error value corresponding to each character data; then, the electronic device may acquire an average value of the prediction error values corresponding to character data in the predicted character set to obtain an error average value; when it is determined that the error average value is less than or equal to a preset average value threshold (for example, 1 to 3 times), the electronic device may determine that the character data satisfies a preset condition, and stop training the formula recognition model, that is, obtain a formula recognition model that has completed training. When it is determined that the error average value is greater than the preset average value threshold, the electronic device may determine that the character data does not satisfy the preset condition, and may return to step 102 to continue training until the preset condition is satisfied.

In step 13, the position of the character data in the mathematical formula is restored according to the preset formula format and structural data, and the mathematical formula in the original image is obtained.

In this step, considering that the predicted character set recognized in step 12 adopts the structure shown in Table 2 and Table 3, the electronic device can restore the position of the character data in the mathematical formula according to the preset formula format and structural data, and the mathematical formula in the original image is obtained.

In this step, comparison of recognition results of mathematical formulas obtained by using the above formula recognition model is as shown in Table 4.

TABLE 4
Recognition accuracy before and after using formula recognition model

| | Counting module | Structure information | Accuracy (%) |
|---|---|---|---|
| Encoder-Decoder | √ | | 45.49 |
| | | √ | 50.25 |
| | √ | √ | 51.95 |

In Table 4, the sign “√” indicates that this function is used. Referring to Table 4, when only the counting module is used, the accuracy of mathematical formula recognition results is improved by 45.49%; when only structural information is used, the accuracy of mathematical formula recognition results is improved by 50.25%. After using counting module and structural information at the same time, the accuracy of mathematical formula recognition results is improved by 51.95%.

So far, in a solution provided in an embodiment of the present disclosure, an original image including a mathematical formula may be acquired; then, the original image is inputted into a formula recognition model to obtain a predicted set outputted by the formula recognition model; the predicted character set includes character data and structural data; subsequently, the position of the character data in the mathematical formula is restored according to a preset formula format and the structural data to obtain the mathematical formula in the original image. In this way, by setting the structural data in the present embodiment, the relative positional relationship of the character data can be characterized, thereby eliminating the problem of missing characters in a complex formula recognition process, improving the recognition accuracy. In other words, in the present embodiment, a double prediction method of the structural information and the character count is adopted to improve the recognition ability of the model for the multi-layer structure nested complex formula, reduce the erroneous recognition of formula caused by the loss of “{” or “}” in the multi-layer nesting, and split the complex formula into component recognition according to different structures, thereby improving the recognition accuracy; in the decoding stage, the multi-scale counting module is added, and a counting loss function is constructed based on the quantity of each character in the label, which weakly supervises the training process, improves the detection rate of characters in each component and improves the recognition accuracy.

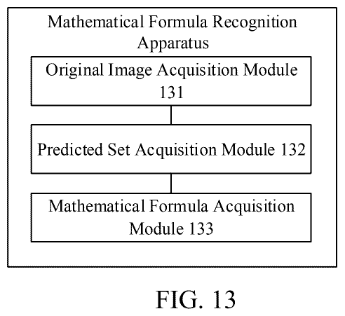

On the basis of a mathematical formula recognition method provided in an embodiment of the present disclosure, the present embodiment further provides a mathematical formula recognition apparatus, referring to FIG. 13, the apparatus includes: an original image acquisition module 131 for acquiring an original image including a mathematical formula; a predicted set acquisition module 132 for inputting the original image to a formula recognition model to obtain a predicted character set outputted by the formula recognition model; wherein the predicted character set includes character data and structural data; a mathematical formula acquisition module 133 for restoring position of character data in the mathematical formula according to a preset formula format and the structural data to obtain the mathematical formula in the original image.

It should be noted that the apparatus embodiment shown in the present embodiment matches contents of the above-described method embodiment, and the contents of the above-described method embodiment may be referred to, and the description thereof will not be repeated herein.

In an exemplary embodiment, there is also provided an electronic device including: a display screen; a processor; a memory for storing a computer program executable by the processor. Herein the processor is configured to execute a computer program in the memory to implement the method as described above.

In an exemplary embodiment, there is also provided a computer-readable storage medium, such as a memory comprising an executable computer program executable by a processor to implement the method as in the above embodiment. Herein, the readable storage medium may be a ROM, a random access memory (RAM), a CD-ROM, a magnetic tape, a floppy disk, an optical data storage device, and the like.

Other embodiments of the present disclosure will readily occur to those of skills in the art upon consideration of the specification and practicing contents disclosed herein. The present disclosure is intended to cover any variations, uses, or adaptations, which follow general principles of the present disclosure and include common sense or conventional technical means in the technical field that are not disclosed in the present disclosure. The specification and embodiments are to be considered exemplary only and the true scope and spirit of the present disclosure are indicated by the following claims.

1. A mathematical formula recognition method, the method comprising:
acquiring an original image comprising a mathematical formula;
inputting the original image into a formula recognition model, to obtain a predicted character set outputted by the formula recognition model; wherein the predicted character set comprises character data and structural data; and
restoring position of the character data in the mathematical formula according to a preset formula format and the structural data, to obtain the mathematical formula in the original image.

2. The method according to claim 1, wherein the formula recognition model comprises an encoder and a decoder;
the encoder is configured to acquire an image feature map corresponding to the original image; and
the decoder is configured to determine the predicted character set corresponding to the original image according to the image feature map.

3. The method according to claim 2, wherein the encoder comprises a DenseNet network or a Transformer network.

4. The method according to claim 2, wherein the decoder comprises a multi-scale counting module, a cyclic decoding module, a feature fusion module, and a character prediction module;
the multi-scale counting module is configured to convert the image feature map into a counting vector of a plurality of preset scales;
the cyclic decoding module is configured to acquire a character latent vector according to the image feature map;
the feature fusion module is configured to perform fusion processing on the counting vector, the character latent vector and a previous predicted character vector, to obtain a target vector; and
the character prediction module is configured to predict the character data and the structural data according to the target vector, respectively.

5. The method according to claim 4, wherein the cyclic decoding module is further configured to acquire a context vector according to the image feature map; and the feature fusion module is further configured to perform the fusion processing on the counting vector, the context vector, the character latent vector and the previous predicted character vector, to obtain the target vector.

6. The method according to claim 5, wherein the feature fusion module is configured to perform linear conversion processing on the count vector, the context vector, the character latent vector, and the previous predicted character vector, respectively, to obtain a first linear vector, a second linear vector, a third linear vector, and a fourth linear vector; and acquire a sum vector of the first linear vector, the second linear vector, the third linear vector, and the fourth linear vector, to obtain the target vector.

7. The method according to claim 4, wherein the multi-scale counting module comprises at least two sub-counting modules and an element average sub-module; the at least two sub-counting modules comprise convolution kernels of different sizes and are used for outputting sub-vectors of a same size, wherein each sub-vector is used for representing a number of times of prediction of character data under a different scale; and the element average sub-module is configured to acquire an average vector of at least two sub-vectors, to obtain a counting vector.

8. The method according to claim 7, wherein the multi-scale counting module comprises a first sub-counting module and a second sub-counting module;
the first sub-counting module is configured to recognize feature information of a first preset scale in the image feature map, to obtain a first sub-vector; wherein the first sub-vector is used to represent a number of times of character data recognized by convolution kernels under the first preset scale; and
the second sub-counting module is configured to recognize feature information of a second preset scale in the image feature map, to obtain a second sub-vector; wherein the second sub-vector is used to represent a number of times of character data recognized by convolution kernels under the second preset scale.

9. The method according to claim 8, wherein the first sub-counting module comprises a first convolution unit, a channel unit, a conversion unit, and a pooling unit;
the first convolution unit is configured to convert the image feature map into a first feature map using convolution kernels of a first preset size;
the channel unit is configured to assign corresponding weights to different channels of the first feature map, to obtain an attention feature map, and multiply the attention feature map with the first feature map, to obtain a channel feature map;
the conversion unit is configured to perform scale transformation processing on the channel feature map, to obtain a counting feature map; and
the pooling unit is configured to perform pooling processing on the counting feature map, to obtain the first sub-vector.

10. The method according to claim 8, wherein the second sub-counting module comprises a second convolution unit, a channel unit, a conversion unit, and a pooling unit;
the second convolution unit is configured to convert the image feature map into a second feature map using convolution kernels of a second preset size;
the channel unit is configured to assign corresponding weights to different channels of the second feature map, to obtain an attention feature map, and multiply the attention feature map with the second feature map, to obtain a channel feature map;
the conversion unit is configured to perform scale transformation processing on the channel feature map, to obtain a counting feature map; and
the pooling unit is configured to perform pooling processing on the counting feature map, to obtain the second sub-vector.

11. The method according to claim 8, wherein the multi-scale counting module further comprises a third sub-counting module, and the third sub-counting module is configured to recognize feature information of a third preset scale in the image feature map, to obtain a third sub-vector;
the third sub-counting module comprises a third convolution unit, a channel unit, a conversion unit, and a pooling unit;
the third convolution unit is configured to convert the image feature map into a third feature map using convolution kernels of a third preset size;
the channel unit is configured to assign corresponding weights to different channels of the third feature map, to obtain an attention feature map; and multiply the attention feature map with the third feature map, to obtain a channel feature map;
the conversion unit is configured to perform scale transformation processing on the channel feature map, to obtain a counting feature map; and
the pooling unit is configured to perform pooling processing on the counting feature map, to obtain the third sub-vector.

12. (canceled)

13. The method according to claim 4, wherein the cyclic decoding module comprises a gate cyclic unit; and
the gate cyclic unit is configured to generate the character latent vector according to a latent vector and the previous predicted character vector;
the cyclic decoding module comprises a first gate cyclic unit and a second gate cyclic unit;
the first gate cyclic unit is configured to generate a first gate vector according to the latent vector and the previous predicted character vector;
the second gate cyclic unit is configured to generate the character latent vector according to the first gate vector;
the cyclic decoding module further comprises an attention sub-module;
the attention sub-module is configured to generate a context vector according to the image feature map, an all-zero tensor, and the first gate vector;
the second gate cyclic unit is configured to generate the character latent vector according to the first gate vector and the context vector;
the attention sub-module comprises a weight acquisition sub-module and a context acquisition sub-module;
the weight acquisition sub-module is configured to perform convolution processing and linear processing on the all-zero tensor to obtain a first feature vector, perform convolution processing on the image feature map to obtain a second feature vector, perform linear processing on the first gate vector to obtain a third feature vector; and perform addition processing on the first feature vector, a second feature vector, and the third feature vector, to obtain a fourth feature vector; and
the context acquisition sub-module is configured to perform first activation processing, linear conversion processing and second activation processing on the fourth feature vector, respectively, to obtain an attention weight, and multiply the image feature map with the attention weight, and then perform summation processing on the image feature map, to obtain the context vector.

14-16. (canceled)

17. The method according to claim 4, wherein the character prediction module comprises a character prediction sub-module and a structure prediction sub-module;
the character prediction sub-module is configured to process the target vector to obtain the predicted character data; and
the structure prediction sub-module is configured to process the target vector to obtain the predicted structural data.

18. The method according to claim 17, wherein the character prediction sub-module comprises a linear conversion unit and an activation unit;
the linear conversion unit is configured to linearly convert the target vector; and
the activation unit is configured to perform activation processing on the linearly converted vector, to obtain the predicted character data;
the structure prediction sub-module comprises a linear conversion unit and an activation unit;
the linear conversion unit is configured to linearly convert the target vector; and
the activation unit is configured to perform activation processing on the linearly converted vector, to obtain the predicted structural data.

19. (canceled)

20. The method according to claim 1, wherein the formula recognition model is trained by the following steps, comprising:
acquiring training sample data; wherein the training sample data comprises a plurality of data sets of mathematical formulas, each data set comprises character data and structural data obtained after expanding according to the preset formula format, and the structural data is used to represent a relative positional relationship of part of characters in a mathematical formula; and
training the formula recognition model to be trained using the training sample data, to obtain the predicted character set outputted by the formula recognition model, wherein the predicted character set comprises character data and structural data; and
stopping the training when the character data is determined to satisfy a preset condition, to obtain the formula recognition model that has completed training.

21. The method according to claim 20, wherein the character data is determined to satisfy the preset condition comprises:
acquiring an occurrence frequency of each character data in the predicted character set, to obtain a predicted frequency corresponding to each character data;
acquiring a difference between the predicted frequency corresponding to each character data and a labeled frequency in a label of the training sample data, to obtain a prediction error value corresponding to each character data;
acquiring an average value of prediction error values corresponding to the character data in the predicted character set, to obtain an error average value; and
determining that the character data satisfies the preset condition when the error average value is determined to be less than or equal to a preset average value threshold.

22. The method according to claim 20, wherein the training sample data is acquired by the following steps, comprising:
acquiring a plurality of original images comprising mathematical formulas;
acquiring character data corresponding to each original image;
creating structural data according to the preset formula format and the character data and arranging the character data, to obtain training sample data corresponding to each original image.

23. A mathematical formula recognition apparatus, comprising:
an original image acquisition module configured to acquire an original image comprising a mathematical formula;
a predicted set acquisition module configured to input the original image to a formula recognition model, to obtain a predicted character set outputted by the formula recognition model; wherein the predicted character set comprises character data and structural data; and
a mathematical formula acquisition module configured to restore position of the character data in the mathematical formula according to a preset formula format and the structural data, to obtain the mathematical formula in the original image.

24. An electronic device comprising
a processor;
a memory for storing a computer program executable by the processor;
wherein the processor is configured to execute the computer program in the memory to implement the method according to claim 1.

25. A non-transitory computer-readable storage medium, wherein when an executable computer program in the storage medium is executed by a processor, the method according to claim 1 is implemented.
